(19) United States
(12) Patent Application Publication
(10) Pub. No.: US 2013/0128959 A1
(43) Pub. Date: May 23, 2013

(54) APPARATUS FOR ENCODING/DECODING SAMPLED COLOR IMAGE ACQUIRED BY CFA AND METHOD THEREOF

(71) Applicant: Industry-Academic Cooperation Foundation, Yons, Seoul (KR)

(72) Inventor: Chul Hee LEE, Goyang-si (KR)

(73) Assignee: Industry-Academic Cooperation Foundation, Yonsei University, Seoul (KR)

(21) Appl. No.: 13/684,102

(22) Filed: Nov. 21, 2012

(30) Foreign Application Priority Data
Nov. 22, 2011 (KR) 10-2011-0122336

(51) Int. Cl. G06T 9/00

(52) U.S. Cl. CPC G06T 9/00; H04N 19/0089
USPC 375/240.03; 382/166; 375/240.25

(57) ABSTRACT

Disclosed are apparatus and methods for encoding/decoding sampled color images acquired by using a CFA according to an exemplary embodiment of the present invention. An apparatus for encoding color images includes: an acquiring unit that acquires color images of a first color coordinate system; a conversion unit that converts the acquired color images of the first color coordinate system into color images of a second color coordinate system by treating a preset number of pixels as a unit; and an encoding unit that encodes the converted color images of the second color coordinate system to generate a compressed image. By this configuration, the present invention can convert color images into the YUV color coordinate system without interpolation of color images, reduce the data size increase caused by conversion into the YUV color coordinate system, and prevent reduced coding efficiency.

### CROSS-REFERENCE TO RELATED APPLICATIONS

This application claims priority to and the benefit of Korean Patent Application No. 10-2011-0122336 filed in the Korean Intellectual Property Office on Nov. 22, 2011, the entire contents of which are incorporated herein by reference.

### TECHNICAL FIELD

The present invention relates to color image encoding, and more particularly, to an apparatus for encoding/decoding sampled color images acquired by using a color filter array (CFA) capable of converting sampled color images of an RGB color coordinate system acquired by using the CFA into color images of another color coordinate system by treating a plurality of pixels as a unit and encoding the converted color images and a method thereof.

### BACKGROUND ART

Most image apparatuses, such as digital cameras, digital camcorders, portable camera phones, and the like, store images in a digital format. For example, most digital cameras compress images using compression techniques such as JPEG (Joint Photographic Expert Group), and the like. Most digital camcorders also store moving pictures in a digital format.

An increasing number of image apparatuses store still pictures and moving pictures in a digital format. Most mobile phones include a camera and can transmit still pictures and moving pictures through digital communications.

In an image system with a single image sensor using a CFA, sampled color images are interpolated into full color images by an interpolation algorithm. A data amount of the full color images generated by the interpolation process is about three times larger than that of the sampled color images.

### SUMMARY OF THE INVENTION

The present invention has been made in an effort to provide an apparatus for encoding/decoding sampled color images acquired by using a color filter array (CFA) capable of converting sampled color images of an RGB color coordinate system acquired by using the CFA into color images of another color coordinate system by treating a plurality of pixels as a unit and encoding the converted color images, and a method thereof.

The present invention has also been made in an effort to provide an apparatus for encoding/decoding sampled color images acquired by using a color filter array (CFA) capable of first rotating sampled color images of a RGB color coordinate system acquired by using the CFA by a preset angle, converting the rotated color images into color images of another color coordinate system by treating a plurality of pixels as a unit, and encoding the converted color images and a method thereof.

The present invention has also been made in an effort to provide an apparatus for effectively encoding/decoding sampled color images acquired by using a color filter array (CFA) capable of acquiring color images by using a single image sensor by treating a plurality of pixels as a unit, converting the acquired color images into color images of another color coordinate system, and encoding the converted color images and a method thereof.

However, objects of the present invention are not limited the above-mentioned matters and other objects can be clearly understood by those skilled in the art from the following descriptions.

An exemplary embodiment of the present invention provides an apparatus for encoding color images, including: an image sensing unit that acquires sampled color images of a first color coordinate system; a color conversion unit that converts the acquired sampled color images of the first color coordinate system into color images of a second color coordinate system by treating a preset number of pixels as a unit; and an encoding unit that encodes the converted color images of the second color coordinate system to generate a compressed image.

The first color coordinate system may be an RGB color coordinate system.

The second color coordinate system may be a YUV color coordinate system.

The color conversion unit converts the color images of the first color coordinate system into the color images of the second color coordinate system by treating adjacent four pixels as a unit.

The color conversion unit converts pixels of R, G1, G2, and B of adjacent locations of the color images of the first color coordinate system into (Y1, u, v) and (Y2, u, v) signals located on the same horizontal axis of the color images of the second color coordinate system.

The encoding unit performs estimation by considering the fact that Y1 and Y2 are originally located on different horizontal axes.

Another exemplary embodiment of the present invention provides an apparatus for encoding color images, including: an image sensing unit that acquires sampled color images of a first color coordinate system; an image rotation unit that rotates the acquired color images of the first color coordinate system by a preset angle; a color conversion unit that converts the rotated color images of the first color coordinate system into color images of a second color coordinate system by treating a preset number of pixels as a unit; and an encoding unit that encodes the converted color images of the second color coordinate system to generate a compressed image.

The image rotation unit rotates the acquired color images of the first color coordinate system by an angle of 45°. The encoding unit performs estimation by considering the fact that Y1 and Y2 are obtained by rotation, calculates residual errors, and outputs transform coefficients. A transform function applied to the residual errors can be optimally designed by considering the rotation of images. The existing methods perform motion estimation in a rectangular unit and the transform function such as DCT is designed assuming a rectangular structure, but may be inefficient for the rotated images. In order to solve the above problems, the present invention improves the coding efficiency by optimizing motion estimation, motion compensation, residual error calculation, the transform function structure applied to the residual errors, and the like, by considering the rotated rectangular structure. For instance, when the image is rotated and is encoded by the existing method, the encoding process is performed in the rectangular structure as illustrated in the left of FIG. 7 (motion estimation, motion compensation, residual error calculation, transform function applied to the residual error). In the present invention, the operations of motion estimation, motion compensation, residual error calculation, and the transform function applied to the residual errors are performed in the rotated rectangular structure as illustrated in the right of FIG. 7. In this case, the rotation angle is identically set.

Another exemplary embodiment of the present invention provides an apparatus for encoding sampled color signals using a single image sensor having a CFA without interpolation, including: a first color conversion unit that converts color signals of a first color coordinate system sampled using the CFA into a second color coordinate system without interpolation; an encoding unit that encodes color signals of the second color coordinate system; a decoding unit that decodes the encoded color signals of the second color coordinate system to generate the decoded color signals of the second color coordinate system; a second color conversion unit that inversely converts the decoded color signals of the second color coordinate system to generate the decoded sampled color signals of the first color coordinate system; a full color interpolation unit that interpolates the decoded sampled color signals of the first color coordinate system to generate full resolution decoded color signals of the first color coordinate system; and a third color conversion unit that converts the generated full resolution decoded color signals of the first color coordinate system to generate full resolution decoded color signals of the second color coordinate system, wherein the encoding unit includes an estimation unit that uses the full resolution decoded color signals of the second color coordinate system generated by the third color conversion unit for estimating a currently encoded block.

The encoding unit may be an intra mode encoding unit.

The encoding unit may be an inter mode encoding unit.

Another exemplary embodiment of the present invention provides an apparatus for encoding color images, including: a single image sensor that is inclined at an angle of 45° from the vertical direction and is arranged to have a diamond shape including four pixels as a unit.

Two of the four pixels arranged in the single image sensor may be green, one thereof may be red, and the remaining one may be blue.

Another exemplary embodiment of the present invention provides an apparatus for encoding color images, including: a receiving unit that receives color signals generated by a single image sensor that is arranged to have a diamond shape including four pixels as a unit; an interpolation unit that interpolates the received color signals for the lattice structure of a display unit; and a display unit that displays the interpolated color signals.

Another exemplary embodiment of the present invention provides an apparatus for encoding moving pictures, including: a quantization determination unit that determines a quantization step; an LPF applying unit that designs a low pass filter (LPF) according to the determined quantization step and applies the designed LPF to input images; and an encoding unit that encodes images outputted from the LPF applying unit to generate compressed images.

Another exemplary embodiment of the present invention provides an apparatus for encoding moving pictures, including: a first quantization unit that quantizes transform coefficients using a first quantization step; an energy calculation unit that calculates an energy value in a specific frequency band of the quantized transform coefficients; and a second quantization unit that determines a second quantization step when the calculated energy value is equal to or larger than a preset threshold and quantizes and outputs the transform coefficients again using the determined second quantization step.

Another exemplary embodiment of the present invention provides an apparatus for decoding compressed signals obtained by encoding sampled color signals using a CFA without interpolation, including: a decoding unit that decodes the received compressed signal to generate decoded color signals of a second color coordinate; a first color conversion unit that inversely converts the decoded color signals of the second color coordinate system to generate decoded sampled color signals of a first color coordinate system; a full color interpolation unit that interpolates the sampled decoded color signals of the first color coordinate system to generate full resolution decoded color signals of the first color coordinate system; and a second color conversion unit that converts the generated full resolution decoded color signals of the first color coordinate system to generate full resolution decoded color signals of the second color coordinate system, wherein the decoding unit uses the full resolution decoded color signals of the second color coordinate system generated by the second conversion unit as a reference image of a currently decoded block.

Another exemplary embodiment of the present invention provides an apparatus for decoding color images, including: a decoding unit that decodes a received compressed signal to generate a decoded color signal of a second color coordinate system; a quantization coefficient calculation unit that calculates quantized transform coefficients; an energy calculation unit that calculates an energy value in a specific frequency band corresponding to the calculated quantized transform coefficients; and a dequantization unit that compares the calculated energy value with a preset threshold and dequantizes the quantized transform coefficient using different quantization steps according to the comparison result.

Another exemplary embodiment of the present invention provides a method for encoding color images, including: acquiring color images of a first color coordinate system; converting the acquired color images of the first color coordinate system into color images of a second color coordinate system by treating a predetermined number of pixels as a unit; and encoding the converted color image of the second color coordinate system to generate the compressed image.

The first color coordinate system may be an RGB color coordinate system.

The second color coordinate system may be a YUV color coordinate system.

Another exemplary embodiment of the present invention provides a method for encoding sampled color signals using a single image sensor having a CFA without interpolation, including: converting color signals of a first color coordinate system sampled using the CFA into a second color coordinate system without interpolation; encoding color signals of the second color coordinate system; decoding the encoded color signals of the second color coordinate system to generate the decoded color signals of the second color coordinate system; inversely converting the decoded color signals of the second color coordinate system to generate decoded sampled color signals of the first color coordinate system; interpolating the decoded sampled color signals of the first color coordinate system to generate full resolution decoded color signals of the first color coordinate system; and converting the generated full resolution decoded color signals of the first color coordinate system to generate full resolution decoded color signals of the second color coordinate system, wherein in the encoding, the generated full resolution decoded color signals of the second color coordinate system are used for estimating a currently encoded block.

Another exemplary embodiment of the present invention provides a method for encoding moving pictures, including: determining a quantization step; designing a low pass filter (LPF) according to the determined quantization step and applying the designed LPF to an input image; and encoding images outputted from the LPF applying unit to generate compressed images.

Another exemplary embodiment of the present invention provides a method for encoding moving pictures, including: quantizing transform coefficients using a first quantization step; calculating an energy value in a specific frequency band of the quantized transform coefficients; and determining a second quantization step when the calculated energy value is equal to or larger than a preset threshold and quantizing the transform coefficients using the determined second quantization step.

Another exemplary embodiment of the present invention provides a method for decoding compressed signals obtained by encoding sampled color signals using a CFA without interpolation, including: decoding the received compressed signal to generate decoded color signals of a second color coordinate system; inversely converting the decoded color signals of the second color coordinate system to generate the decoded sampled color signals of the first color coordinate system; interpolating the decoded sampled color signals of the first color coordinate system to generate full resolution decoded color signals of the first color coordinate system; and converting the generated full resolution decoded color signals of the first color coordinate system to generate full resolution decoded color signals of the second color coordinate system, wherein in the decoding, the generated full resolution decoded color signals of the second color coordinate system are used as a reference image of a currently decoded block.

Another exemplary embodiment of the present invention provides a method for decoding color images, including: decoding the received compressed signals to calculate quantized transform coefficients; calculating an energy value in a specific frequency band of the calculated quantized transform coefficients; and comparing the calculated energy value with a preset threshold and dequantizing the quantized transform coefficient using different quantization steps according to the comparison result.

As set forth above, the exemplary embodiments of the present invention can convert the sampled color images of the RGB color coordinate system acquired by using the CFA into the color images of the YUV color coordinate system by treating the plurality of pixels as a unit and encode the converted color images, thereby performing the conversion into the YUV color coordinate system without interpolating the sampled color images.

The exemplary embodiments of the present invention can convert the sampled color images of the RGB color coordinate system acquired by using the CFA into the color images of the YUV color coordinate system by treating the plurality of pixels as a unit and encode the converted color images, thereby reducing the data size in the YUV color coordinate system.

The exemplary embodiments of the present invention can rotate the color images of the RGB color coordinate system acquired by using the CFA by a preset angle, convert the rotated color images into color images of the YUV color coordinate system by treating the plurality of pixels as a unit, and encode the converted color images, thereby preventing potential coding inefficiency.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a first diagram illustrating an apparatus for encoding color images according to an exemplary embodiment of the present invention.

FIG. 2 is a diagram illustrating a CFA having a Bayer pattern according to an exemplary embodiment of the present invention.

FIG. 3 is a first diagram for describing a process of converting a color coordinate system according to an exemplary embodiment of the present invention.

FIG. 4 is a first diagram illustrating a method for encoding color images according to an exemplary embodiment of the present invention.

FIG. 5 is a diagram illustrating an apparatus for decoding color images according to an exemplary embodiment of the present invention.

FIG. 6 is a second diagram illustrating the apparatus for encoding color images according to the exemplary embodiment of the present invention.

FIG. 7 is a second diagram for describing the process of converting a color coordinate system according to the exemplary embodiment of the present invention.

FIG. 8 is a second diagram illustrating a method for encoding color images according to the exemplary embodiment of the present invention.

FIG. 9 is a third diagram for describing the process of converting a color coordinate system according to an exemplary embodiment of the present invention.

FIG. 10 is a third diagram illustrating the apparatus for encoding color images according to the exemplary embodiment of the present invention.

FIG. 11 is a second diagram illustrating the apparatus for decoding color images according to the exemplary embodiment of the present invention.

FIGS. 12A to 12H are diagrams illustrating a process of improving coding efficiency by considering the fact that Y1 and Y2 are located on different axes.

FIG. 13 illustrates an example of an intra prediction mode of H.264.

FIGS. 14A to 14C are diagrams illustrating a process of improving performance of intra prediction and inter prediction by considering the fact that Y1 and Y2 are located on different axes.

FIG. 15 is a diagram illustrating a process of performing encoding by controlling a quantization step.

FIG. 16 is a diagram illustrating a process of decoding compressed data calculated by the method of FIG. 15.

FIG. 17 is a diagram illustrating a process of designing, applying, and encoding LPF according to the quantization step.

FIGS. 18A and 18B are third diagrams for describing a process of converting a color coordinate system according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

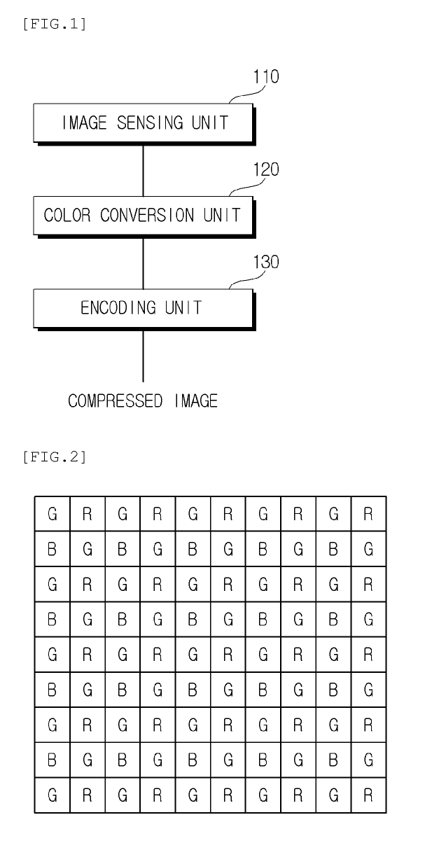

Hereinafter, an apparatus and a method for encoding/decoding sampled color images acquired by using a color filter array (CFA) according to an exemplary embodiment of the present invention will be described with reference to FIGS. 1 to 18. Exemplary embodiments of the present invention will be described in detail with focus on parts and function necessary to understand the operations and actions of the present invention. Throughout the specification, reference numbers of each drawing denote identical components.

In particular, the present invention proposes a new method for converting color images of the RGB color coordinate system acquired by using the CFA into color images of a YUV color coordinate system by treating a plurality of pixels as a unit and encoding the converted color images of the YUV color coordinate system.

The present invention can rotate the color images of the RGB color coordinate system acquired by using the CFA by a preset angle, convert the rotated color images into color images of the YUV color coordinate system by treating the plurality of pixels as a unit, and encode the converted color images.

FIG. 1 is a first diagram illustrating an apparatus for encoding color images according to an exemplary embodiment of the present invention.

As illustrated in FIG. 1, the apparatus for encoding color images according to an exemplary embodiment of the present invention may be configured to include an image sensing unit 110, a color conversion unit 120, an encoding unit 130, and the like. In this case, the color images can be a concept including still pictures, moving pictures, and the like.

The image sensing unit 110 may use a single image sensor having a CFA to acquire sampled color images of the RGB color coordinate system. Here, the sampled color image is an image acquired by using the CFA and refers to an image of which one pixel has only one color.

In this case, the acquired color image may be a CFA with the Bayer pattern.

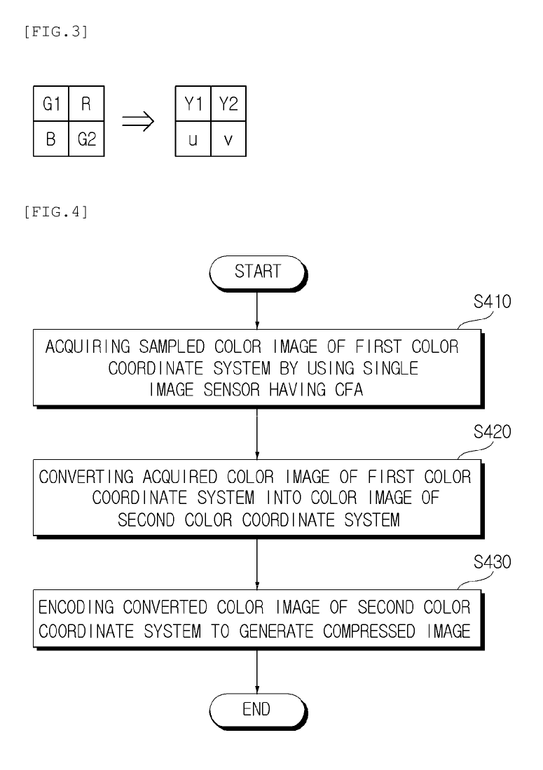

FIG. 2 is a diagram illustrating a CFA having the Bayer pattern according to an exemplary embodiment of the present invention.

FIG. 2 illustrates a color image of the Bayer pattern CFA having red (R) pixels, green (G) pixels, and blue (B) pixels according to the exemplary embodiment of the present invention.

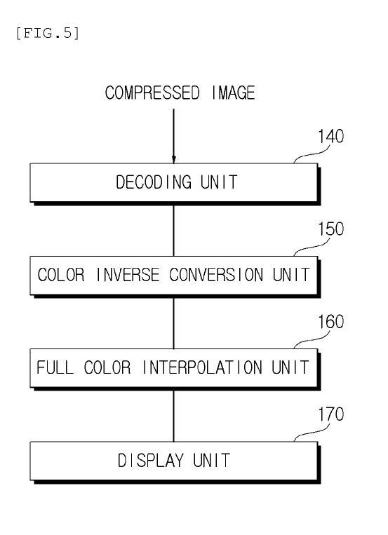

The color conversion unit 120 converts the color images of the RGB color coordinate system into the color images of the YUV color coordinate system by treating a preset number of pixels as a unit. This will be described with reference to FIG. 3.

FIG. 3 is a first diagram describing a process of color coordinate system conversion according to an exemplary embodiment of the present invention.

As illustrated in FIG. 3, the color conversion unit 120 according to the exemplary embodiment of the present invention can convert the color images of the RGB color coordinate system into the color images of the YUV color coordinate system by treating four adjacent pixels as a unit.

For example, pixels R, G1, G2, and B at adjacent locations of the color images of the RGB color coordinate system are converted into signals (Y1, u, v) and (Y2, u, v) that are located on the same horizontal axis of the color images of the YUV color coordinate system.

In this case, the (Y1, Y2, u, v) signal can be obtained using the following Equation 1:

Y1=w11*R+w12*G1+w13*B

Y2=w21*R+w22*G1+w23*B

u=w31*R+w32*G1+w32*G2+w33*B

v=w41*R+w42*G1+w42*G2+w43*B [Equation 1]

In Equation 1, w11, w12, w13, w21, w22, w23, w31, w32, w32, w33, w41, w42, w42, and w43 represent weight values. For example, one may use that w11=w21, w12=w22, and w13=w23.

The following Equation 2 can be defined by modifying Equation 1.

Y1=w11*R+w12*G1+w13*B

Y2=w21*R+w22*G2+w23*B

u=w31*R+w32*G1+w33*B

v=w41*R+w42*G2+w43*B. [Equation 2]

In Equation 2, one G signal is used to generate u and v signals. Equation 2 uses the G signal located on the same horizontal axis to generate u and v signals and is suitable for images having many horizontal lines. Even in this case, one may use that w11=w21, w12=w22, and w13=w23.

On the other hand, u and v signals can be generated by changing the roles of G1 and G2 as illustrated in the following Equation 3:

Y1=w11*R+w12*G1+w13*B

Y2=w21*R+w22*G2+w23*B

u=w31*R+w32*G2+w33*B

v=w41*R+w42*G1+w43*B. [Equation 3]

When the YUV signals are generated using the RGB signals at the adjacent locations, they have the YUV422 structure which can be applied to the existing codec.

The encoding unit 130 encodes the color images of the converted YUV color coordinate system to generate compressed images. The compressed images may also be stored in a storage unit (not illustrated).

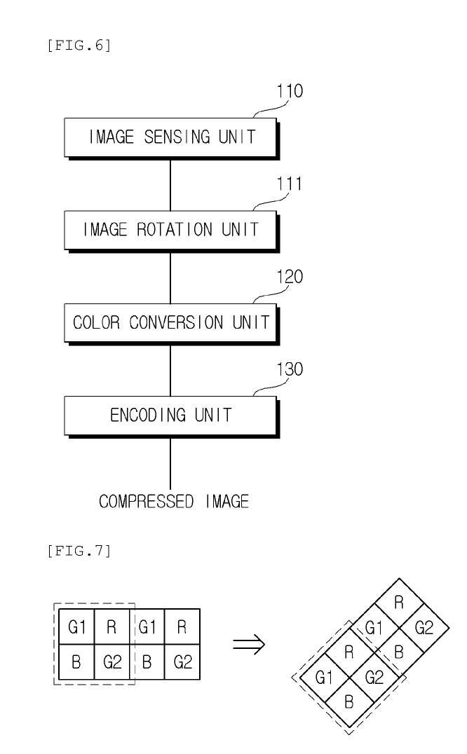

FIG. 4 is a first diagram illustrating a method for encoding color images according to an exemplary embodiment of the present invention.

As illustrated in FIG. 4, an apparatus (hereinafter, an encoding apparatus) for encoding color images according to the exemplary embodiment of the present invention may acquire color images of a first color coordinate system (S410).

Next, the encoding apparatus can convert the acquired color images of the first color coordinate system into color images of a second color coordinate system by treating a predetermined number of adjacent pixels as a unit. Here, the encoding apparatus converts the first color coordinate system into the second color coordinate system by treating four pixels as a unit (S420).

Next, the encoding apparatus encodes the converted color images of the second color coordinate system to generate compressed images (S430). Here, the first color coordinate system may represent the RGB color coordinate system and the second color coordinate system may represent the YUV color coordinate system, but the exemplary embodiment of the present invention is not necessarily limited thereto.

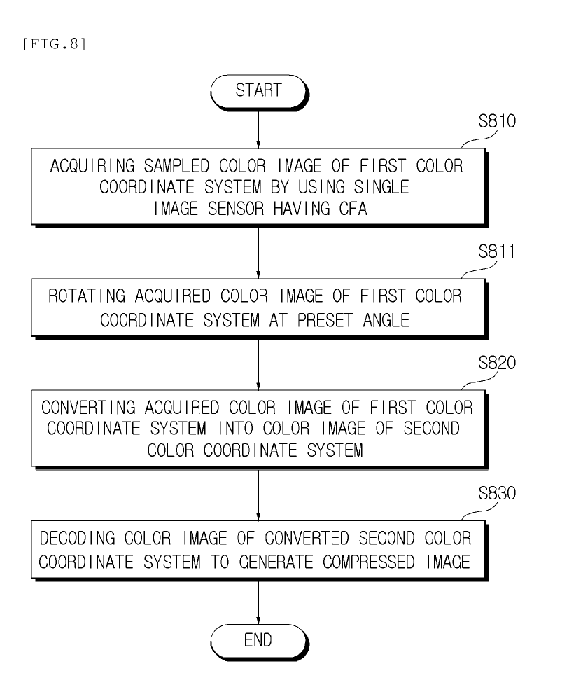

FIG. 5 is a first diagram illustrating an apparatus for decoding color images according to the exemplary embodiment of the present invention.

As illustrated in FIG. 5, an apparatus for decoding color images according to an exemplary embodiment of the present invention may be configured to include a decoding unit 140, a color inverse conversion unit 150, a full color interpolation unit 160, a display unit 170, and the like.

When the decoding unit 140 receives the compressed image, the decoding unit 140 can decode the compressed image to reconstruct the sampled color images of the YUV color coordinate system. In this case, the decoding unit 140 reconstructs the color images of the RGB color coordinate system, the color images of the YUV color coordinate system, or the like, into the format used at the time of encoding.

The color inverse conversion unit 160 can inversely convert the reconstructed color images of the YUV color coordinate system into the color images of the RGB color coordinate system.

The full color interpolation unit 150 can interpolate the converted RGB color images to generate the full color images.

The display unit 170 can display the generated full color images. In this case, the display unit 170 converts the inputted full color images according to the display type.

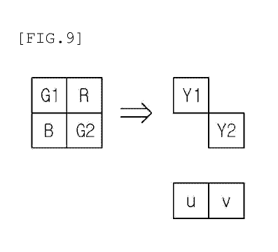

FIG. 6 is a second diagram illustrating the apparatus for encoding color images according to the exemplary embodiment of the present invention.

As illustrated in FIG. 6, the apparatus for encoding color images according to an exemplary embodiment of the present invention may be configured to include an image sensing unit 110, an image rotation unit 111, a color conversion unit 120, an encoding unit 130, and the like.

The image sensing unit 110 uses a single image sensor having a CFA to acquire sampled color images of an RGB color coordinate.

The image rotation unit 111 rotates the acquired color images of the RGB color coordinate system by a predetermined angle. In this case, the image rotation unit 111 rotates the color images of the RGB color coordinate system by an angle of 45° clockwise or an angle of 45° counter-clockwise.

The reason for rotating the images is that when two pixels at different vertical positions are located on the same horizontal axis, coding efficiency may be reduced due the occurrence of high frequency components.

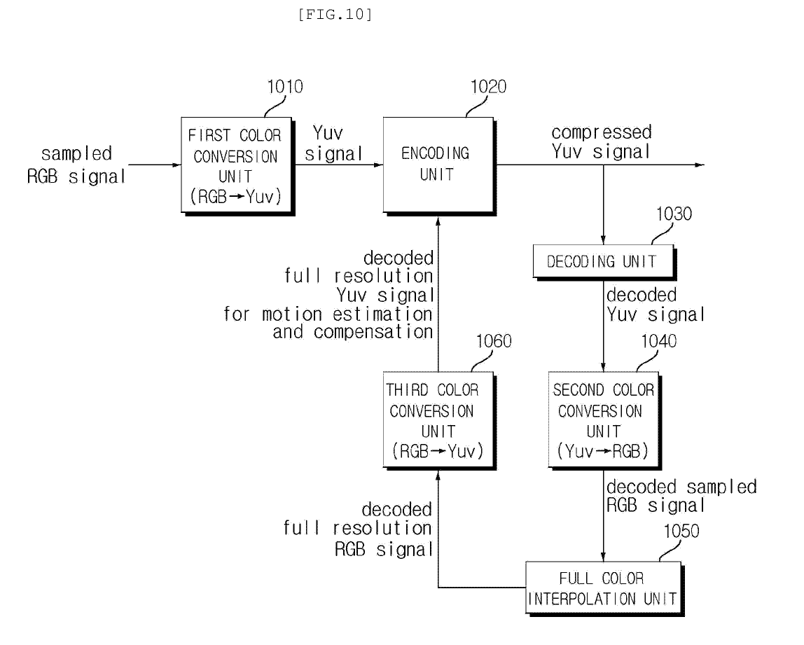

FIG. 7 is a second diagram for describing the process of color coordinate system conversion according to the exemplary embodiment of the present invention.

As illustrated in FIG. 7, the color conversion unit 120 according to the exemplary embodiment of the present invention can rotate the color images of the RGB color coordinate system by an angle of 45° and convert the rotated color images into the color images of the YUV color coordinate system by treating four adjacent pixels as a unit.

For example, two pixels G1 and G2 at different vertical positions are located on the same horizontal axis.

The color conversion unit 120 can convert the color images of the RGB color coordinate system into the color images of the YUV color coordinate system by treating a preset number of pixels as a unit.

The encoding unit 130 can encode the converted color images of the YUV color coordinate system to generate compressed images. The compressed images may also be stored in a storage unit (not illustrated).

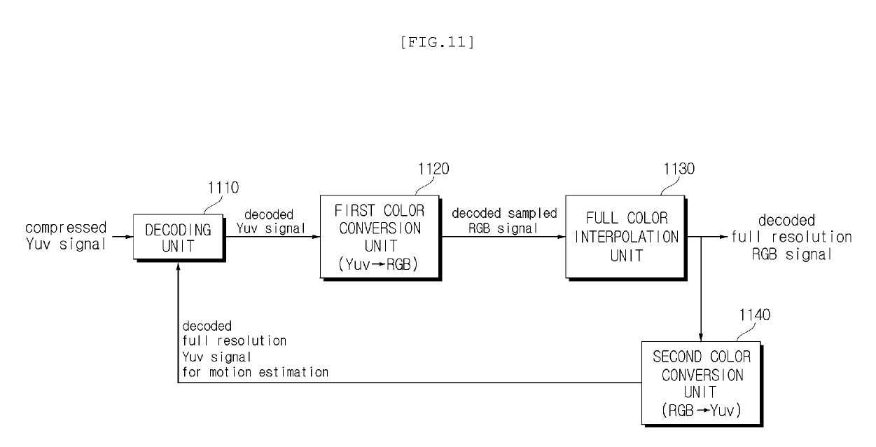

FIG. 8 is a second diagram illustrating a method for encoding color images according to an exemplary embodiment of the present invention.

As illustrated in FIG. 8, the apparatus (hereinafter, an encoding apparatus) for encoding color images according to the exemplary embodiment of the present invention may acquire the color images of the first color coordinate system (S810).

Next, the encoding apparatus can rotate the acquired color images of the first color coordinate systems at a preset angle (S811).

Next, the encoding apparatus can convert the rotated color images of the first color coordinate system into color images of a second color coordinate system by treating a predetermined number of adjacent pixels as a unit. Here, the encoding apparatus converts the first color coordinate system into the second color coordinate system by treating four pixels as a unit (S820).

Next, the encoding apparatus encodes the converted color images of the second color coordinate system to generate compressed images (S830). Here, the first color coordinate system may represent the RGB color coordinate system and the second color coordinate system may represent the YUV color coordinate system, but the exemplary embodiment of the present invention is not necessarily limited thereto. At the time of encoding, coding efficiency can be improved by performing estimation, computation of residual errors and transform by considering that Y1 and Y2 are computed after rotation. In other words, a transform function applied to residual errors may be designed by considering the image rotation. In the existing method, motion estimation is performed in a rectangular unit and the transform function such as DCT is designed assuming a rectangular structure. However, such existing method may be inefficient for the rotated images. In order to solve these problems, the present invention improves coding efficiency by optimizing motion estimation, motion compensation, residual error calculation, transform function structure applied to the residual errors, and the like, by considering the rotated rectangular structure. For instance, when the image is rotated and is encoded by the existing method, the encoding process is performed in the rectangular structure as illustrated in the left of FIG. 7 (motion estimation, motion compensation, residual error calculation, and transform function applied to the residual errors). In the present invention, the operations of motion estimation, motion compensation, residual error calculation, and the transform function applied to the residual errors, and the like, are performed in the rotated rectangular structure as illustrated in the right of FIG. 7. In this case, the rotation angle is identically set.

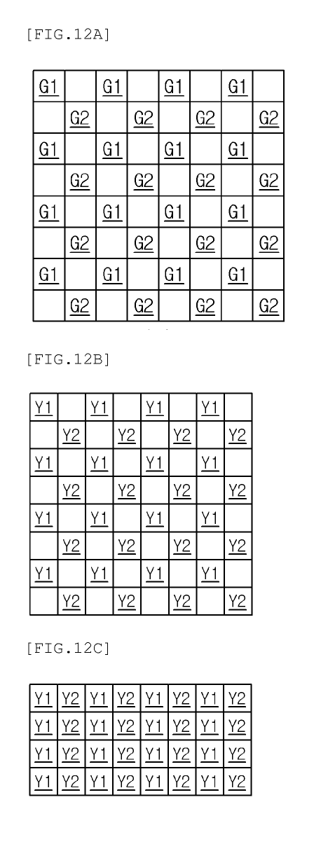

Meanwhile, as illustrated in FIG. 3, when G1 and G2 values located on different horizontal axes are converted into Y1 and Y2 that are located on the same horizontal axis, high frequency components not present in an original image may occur, which results in reduced coding efficiency. When G1 and G2 values located on different horizontal axes are converted into Y1 and Y2 on the same horizontal axis, errors may occur in motion estimation and motion compensation and it is difficult to obtain optimal results. In the present invention, a method for solving the above problems will be described with reference to FIGS. 9 to 14.

FIG. 9 is a third diagram for describing the process of color coordinate system conversion according to an exemplary embodiment of the present invention.

As illustrated in FIG. 9, the coding efficiency may be improved by performing the encoding by considering the fact that Y1 and Y2 are originally located on different horizontal axes. In other words, in the case of motion compensation, similar blocks are searched in neighbouring frames. In this case, an optimal motion vector is obtained by considering the fact that Y1 and Y2 are located on different horizontal axes in the original image. In the case of intra mode, the current block is estimated from neighbouring blocks/pixels and the optimal solution can be obtained by considering the fact that Y1 and Y2 are located on different horizontal axes in the original image. In other words, though Y1 and Y2 located on different horizontal axes in the original image are stored on the same horizontal axis, an optimal solution is obtained when reducing residual errors by estimation by considering the fact that Y1 and Y2 are originally located on different horizontal axes.

This will be described below in detail. In moving picture encoding, inter prediction uses neighbouring frame information to reduce residual errors, thereby increasing coding efficiency. For this purpose, motion compensation techniques are used, which requires motion estimation. In the present invention, coding efficiency performance is improved by performing motion estimation by considering the fact that Y1 and Y2 are originally located on the different horizontal axes.

In other words, when Yuv reference images are generated by the decoding process, reference RGB images thereto are generated and these reference RGB images are used for encoding neighbouring frames and decoding. In the present invention, since the reference RGB images are generated as the sampled RGB images, a demosaicking technique is required. In this case, various demosaicking techniques may be used. When the Yuv reference images are generated in the decoder, the reference RGB images corresponding thereto are generated. The demosaicking process is applied to the generated reference RGB images to produce full resolution YUV images. These reference full resolution YUV images are used for encoding neighbouring frames and decoding.

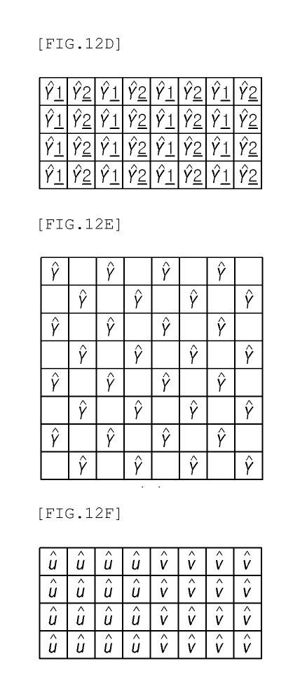

FIG. 10 is a third diagram illustrating the apparatus for encoding color images according to the exemplary embodiment of the present invention.

As illustrated in FIG. 10, the apparatus for encoding color images according to the exemplary embodiment of the present invention may be configured to include a first color conversion unit 1010, an encoding unit 1020, a decoding unit 1030, a second color conversion unit 1040, a full color interpolation unit 1050, a third color conversion unit 1060, and the like.

In the present invention, when the Yuv images are decoded and color format conversion is applied, reference RGB images are generated as sampled RGB images, a demosaicking technique is required. In this case, various demosaicking techniques may be used.

When the decoding unit 1030 receives the compressed image, the decoding unit 1030 decodes the compressed image to produce decoded color images of the YUV color coordinate system.

The second color conversion unit 1040 performs color inverse conversion to the decoded Yuv images to generate the decoded sampled RGB images having the original CFA pattern.

The full color interpolation unit 1050 interpolates the decoded sampled RGB images. In other words, a demosaicking technique is applied to the decoded sampled RGB signals, thereby generating the decoded full resolution RGB color images.

The third color conversion unit 1060 generates the decoded full resolution Yuv reference signals from the decoded full resolution reference RGB images. The decoded full resolution Yuv reference signals are used for motion estimation and motion compensation in the encoding unit 1020, thereby improving coding efficiency.

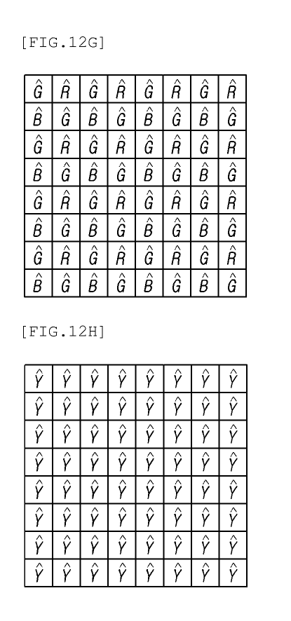

FIG. 11 is a second diagram illustrating the apparatus for decoding color images according to the exemplary embodiment of the present invention.

As illustrated in FIG. 11, the apparatus for decoding color images according to the exemplary embodiment of the present invention may be configured to include a decoding unit 1110, a first color conversion unit 1120, a full color interpolation unit 1130, a second color conversion unit 1140, and the like.

In this configured decoding apparatus, the decoded full resolution Yuv reference signals are generated by the same process as in the foregoing encoding apparatus and can be used as the reference images in the decoding unit.

At present, in most coding methods, Y signal is first used to perform motion estimation and encoding Y, u, v signals is performed. In other words, a series of processes such as motion estimation, motion compensation, the transform (for example, discrete cosine transform (DCT)), quantization, entropy coding, and the like, are simultaneously performed on the three channel (for example, Y, u, v) signals to obtain optimal solution. A series of encoding processes such as motion estimation, motion compensation, transforms (for example, DCT), quantization, entropy coding, and the like, that are used in various coding schemes are described in detail in numerous related arts and, therefore, will be omitted herein.

In the present invention, coding performance can be improved by simultaneously performing encoding on the three channels even in the intra mode estimation by utilizing other channel information.

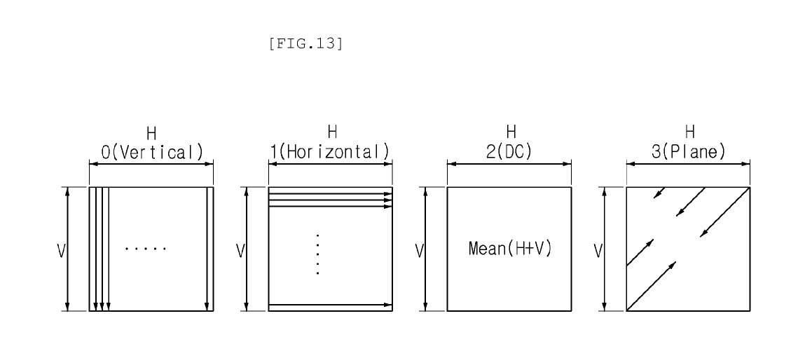

FIGS. 12A to 12H are diagrams illustrating a process of improving coding efficiency by considering the fact that Y1 and Y2 are located on different axes.

As illustrated in FIGS. 12A to 12H, the original green pixel locations are illustrated in FIG. 12A. The corresponding locations of Y pixels are illustrated in FIG. 12B, but the locations are stored in memory as illustrated in FIG. 12C. If motion vector estimation, motion compensation, and intra prediction are performed under the assumption that Y1 and Y2 located on the same horizontal axis as illustrated in FIG. 12C though they are originally located on different horizontal axes, coding efficiency can be reduced. In order to solve the above problems, in the present invention, the encoded Y signals are decoded (FIG. 12D) and are rearranged at the original locations (FIG. 12E). The decoded RGB images corresponding to the original CFA pattern are obtained (FIG. 12G) by using the decoded uv signals (FIG. 12F) and the rearranged decoded Y signals. The full resolution image may be obtained by interpolating the decoded RGB images to obtain the decoded full resolution Y image (FIG. 12H). In other words, the full resolution Y image corresponding to the previously encoded frames or blocks can be obtained and motion vector estimation, motion compensation, and intra prediction can be efficiently performed by using the full resolution Y image.

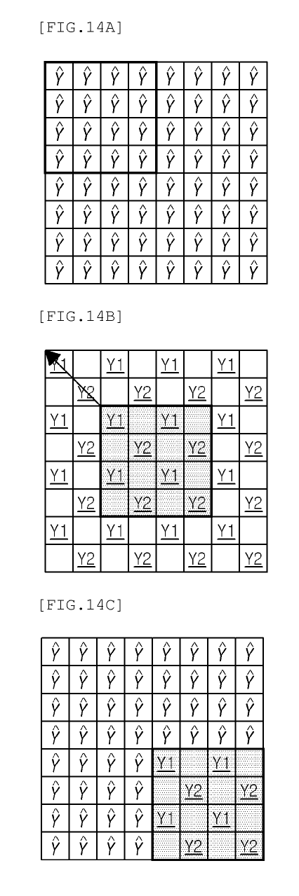

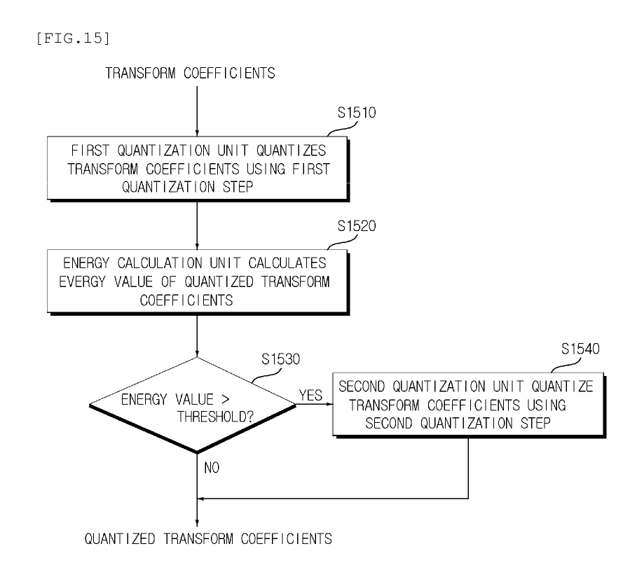

FIG. 13 illustrates an example of an intra prediction mode of H.264. FIGS. 14A to 14C are diagrams illustrating a process of improving performance of intra prediction and inter prediction by considering the fact that Y1 and Y2 are located on different axes.

From the previously encoded block, the full resolution Y image (\hat{γ}) is obtained by the aforementioned method. When the currently encoded block (gray) is estimated from the previously encoded block, intra prediction and inter mode motion estimation/compensation, are performed by considering the fact that Y1 and Y2 are located on different horizontal axes though Y1 and Y2 are stored in the memory as being located on the same horizontal axis as illustrated in FIG. 14. FIGS. 14A and 14B illustrate an inter-frame motion estimation process. When the block corresponding to the currently encoded block (gray, FIG. 14B) is searched in the encoded reference image (FIG. 14A), accurate motion vector search and motion compensation can be performed by considering the fact that Y1 and Y2 are located on different horizontal axes. In particular, when the motion vector is not integer, prediction accuracy can be improved.

When intra mode prediction is performed as illustrated in FIG. 13 after Y1 and Y2 located on different horizontal axes move to the same horizontal axis as illustrated in FIG. 12C, estimation accuracy decreases. However, as illustrated in FIG. 14C, from the previously encoded block the full resolution Y image is obtained by the aforementioned method and intra prediction is performed by considering the fact that Y1 and Y2 are located on different horizontal axes, thereby improving accuracy of estimation obtains.

Generally, when motion estimation is inaccurate, large residual errors occur. In this case, when the transform is performed using DCT or the like, a large amount of energy is produced. In order to accurately encode these residual errors, small quantization steps need to be used. However, when a small quantization step is used, a large number of bits are generated, thereby decreasing coding efficiency.

In order to solve this problem, the present invention discloses a method of adaptively changing a quantization step according to the residual error energy.

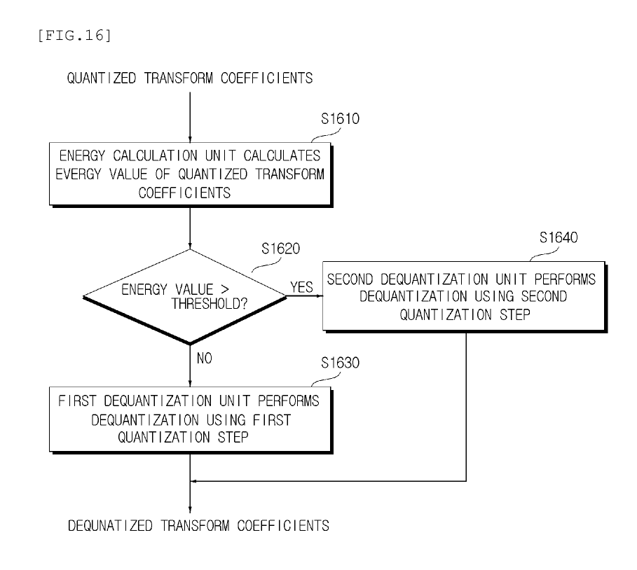

FIG. 15 is a diagram illustrating a process of performing encoding by controlling the quantization step. As illustrated in FIG. 15, in the present invention, after the quantization is performed by applying the transform such as DCT, and the like, to residual errors in each block or coding unit during the encoding process, if it is determined that the energy is larger than a specific value by examining output bit streams, the quantization step is reduced and the quantization is repeated, thereby generating the bit stream. In this case, the energy included in the bit stream is increased due to the reduced quantization step.

In other words, when a preset first quantization step is determined, a first quantization unit uses the first quantization step (for example, quantization parameter (QP)) to quantize a transform coefficient (S1510).

An energy calculation unit calculates an energy value in a specific frequency band corresponding to a quantized transform coefficient produced by a first quantization unit 1211a (S1520).

The energy calculation unit compares the calculated energy value with the preset threshold (S1530) and the second quantization unit determines a preset second quantization step if it is determined that the calculated energy value is equal to or larger than a preset threshold based on the comparison result and uses the determined second quantization step to quantize the transform coefficients again (S1540).

On the other hand, the first quantization unit uses the quantized transform coefficients produced by using the first quantization step if the calculated energy value is below the preset threshold.

In the decoding process of the present invention, when the energy included in the bit stream is larger than the specific value, the decoding can be performed by adaptively controlling the quantization step.

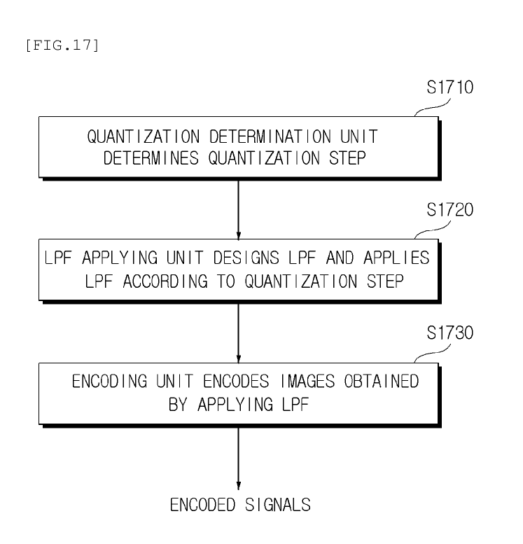

FIG. 16 is a diagram illustrating a process of decoding compressed data produced by the method of FIG. 15.

As illustrated in FIG. 16, the energy in a specific frequency band of the quantized transform coefficients is calculated. The dequantization is performed using quantization step D1 when the calculated energy value is smaller than a specific threshold T. When the calculated energy value is larger than the threshold, the dequantization is performed using quantization step D2.

In other words, the energy calculation unit calculates the energy value in a specific frequency band of the decoded quantized transform coefficients (S1610).

The energy calculation unit compares the calculated energy value with the preset threshold (S1620) and when the calculated energy value is smaller than or equal to the preset threshold based on the comparison result, the first dequantization unit performs dequantization using the first quantization step (S1630).

On the other hand, the second dequantization unit performs dequantization using the second quantization step when the calculated energy value is larger than the preset threshold (S1640).

For example, when encoding is performed using QP=32, if the energy of the bit stream generated in the specific block is larger than the specific value, the corresponding block is again encoded using a smaller QP (e.g., 27).

The present invention performs decoding using QP=27 during the decoding process when the bit stream energy of the specific block exceeds the specific value and performs decoding using QP=32 when the bit stream energy of the specific block is smaller than or equal to the specific value. Here, the present invention variably can control the QP value by considering the energy included in a specific frequency band (for example, high frequency components), instead of considering the total energy of the bit stream. For example, when 4×4 DCT is used, 16 transform coefficients are generated as shown in the following Equation 4:

{cᵢ|i=0,1, . . . ,15} [Equation 4]

In Equation 4, C₀ represents the DC component and C₁₅ represents the highest frequency. When these 16 transform coefficients are quantized, the quantized transform coefficients are generated as shown in the following Equation 5:

{ĉᵢ|i=0,1, . . . ,15} [Equation 5]

In this case, the total energy Eₜₒₜₐₗ of the quantized coefficients can be calculated as shown in the following Equation 6:

$${E}_{total} = {\sum }_{i = 0}^{15} {( \hat{{c}_{i}} )}^{2} \qquad [ Equation 6 ]$$

Generally, since multiplication require a large number of operations, a sum of absolute values can be used instead of the total energy as shown in the following Equation 7:

$${E}_{total} = {\sum }_{i = 0}^{15} \vert \hat{{c}_{i}} \vert \qquad [ Equation 7 ]$$

When the present invention considers only the energy in a specific frequency band, energy E_{sub} in a specific frequency band can be calculated as shown in the following Equation 8:

$${E}_{sub} = {\sum }_{i = K}^{L} {( \hat{{c}_{i}} )}^{2} , \\ 0 \leq K \leq L \leq 15 \qquad [ Equation 8 ]$$

As illustrated in the previous embodiments, when different quantization steps are used depending on the bit stream energy, the encoder and the decoder need to share the information on the method for controlling the quantization step. This can be adaptively applied and the encoder can transmit the information on the method for changing a quantization step, together with compressing video data.

When G signals on different horizontal lines produce Y signals on the same line, high frequency components that are not present in the original image may occur in the Y image and reduce coding efficiency.

In order to solve this problem, the present invention selectively applies a filter by considering the quantization step.

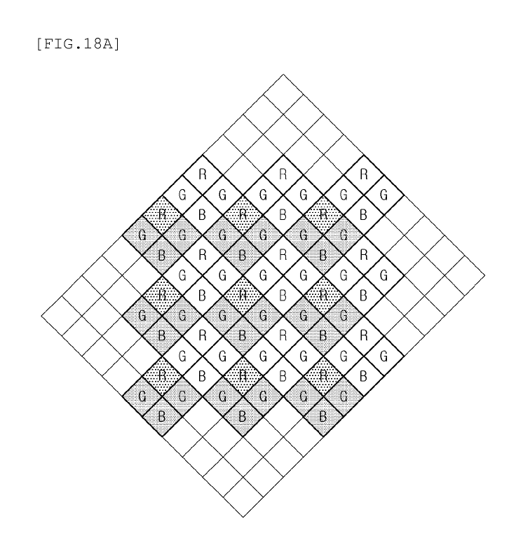

FIG. 17 is a diagram illustrating a process of designing LPF, applying the LPF and encoding depending on the quantization step.

As illustrated in FIG. 17, when encoding is performed using a large quantization step, a low pass filter is applied and then, the Yuv signals are generated. The highest frequency energy included in compressed video is generally determined by the quantization step. When the encoding process and the decoding process are viewed as a single compression transmission system, a frequency response of the compression transmission system is changed depending on various QP values. The system does not have a constant frequency response for input images, but exhibit a similar frequency response in a broad sense. Therefore, when the quantization step is determined, the high frequency energy that can be compressed and transmitted is limited to a certain degree. Therefore, the present invention first applies LPF to signals by considering the quantization step and then encodes the signals.

In other words, when the quantization determination unit determines the quantization step (S1710), the LPF applying unit designs the low pass filter (LPF) according to the determined quantization step and applies the designed LPF to the input image (S1720).

The encoding unit encodes the image outputted from the LPF applying unit to generate compressed images (S1730).

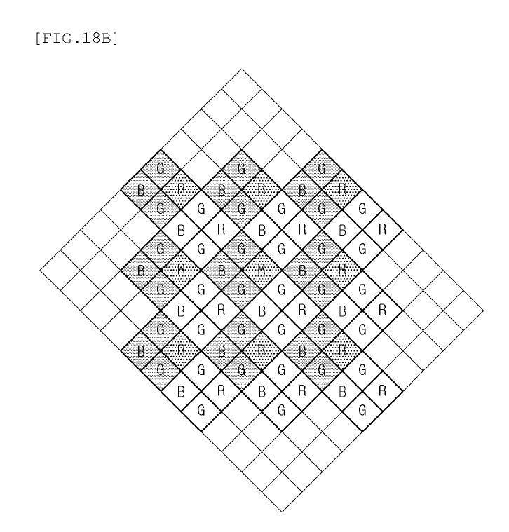

In order to solve the problem of unnecessary high frequency components after the color conversion, the CFA can be designed as illustrated in FIG. 18.

FIGS. 18A and 18B are third diagrams for describing a process of converting a color coordinate system according to the exemplary embodiment of the present invention.

As illustrated in FIG. 18, in the structure, four pixels having a diamond shape form one unit. When color format conversion is applied to the four pixels, Y signal is located in a squared lattice, thereby improving coding efficiency. However, since most displays have a squared lattice structure, interpolation is required to display such signals. In other words, for compatibility with existing displays, the decoder needs to interpolate and output final signals which are compatible to the lattice structure of the display unit.

In other words, the apparatus for encoding/decoding color images according to the exemplary embodiment of the present invention may further include a display unit that displays color signals generated by the single image sensor. Here, the display unit comprises a receiving unit that receives color signals generated by the single image sensor and an interpolation unit that interpolates the received color signals which are compatible to the lattice structure of the display unit.

As described above, the exemplary embodiments have been described and illustrated in the drawings and the specifications. The exemplary embodiments were chosen and described in order to explain certain principles of the invention and their practical applications, to thereby enable others skilled in the art to make and utilize various exemplary embodiments of the present invention, as well as various alternatives and modifications thereof. As is evident from the foregoing descriptions, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for encoding color images, comprising:
an image sensing unit that acquires sampled color images of a first color coordinate system;
a color conversion unit that converts the acquired sampled color images of the first color coordinate system into color images of a second color coordinate system without interpolation by treating a preset number of pixels as a unit; and
an encoding unit that encodes the converted color images of the second color coordinate system to generate a compressed image.

2. The apparatus of claim 1, wherein the color conversion unit converts pixels of R, G1, G2, and B located at adjacent locations of the color images of the first color coordinate system into (Y1, u, v) and (Y2, u, v) signals located on the same horizontal axis of the color images of the second color coordinate system and the encoding unit performs estimation by considering the fact that Y1 and Y2 are located on different horizontal axes.

3. An apparatus for encoding color images, comprising:
an image sensing unit that acquires sampled color images of a first color coordinate system;
an image rotation unit that rotates the acquired color images of the first color coordinate system by a preset angle;
a color conversion unit that converts the rotated color images of the first color coordinate system into color images of a second color coordinate system by treating a preset number of pixels as a unit; and
an encoding unit that encodes the converted color images of the second color coordinate system to generate a compressed image.

4. The apparatus of claim 3, wherein the encoding unit performs estimation and calculates residual errors to perform a transform process by considering the fact that the converted color images are rotated.

5. An apparatus for encoding sampled color signals using a single image sensor having a CFA without interpolation, comprising:
a first color conversion unit that converts color signals of a first color coordinate system sampled using the CFA into a second color coordinate system without interpolation;
an encoding unit that encodes color signals of the second color coordinate system;
a decoding unit that decodes the encoded color signals of the second color coordinate system to generate the decoded color signals of the second color coordinate system;
a second color conversion unit that inversely converts the decoded color signals of the second color coordinate system to generate the decoded sampled color signals of the first color coordinate system;
a full color interpolation unit that interpolates the decoded sampled color signals of the first color coordinate system to generate decoded full resolution color signals of the first color coordinate system; and
a third color conversion unit that converts the decoded full resolution color signals of the first color coordinate system to generate decoded full resolution color signals of the second color coordinate system,
wherein the encoding unit includes an estimation unit that uses the decoded full resolution color signals of the second color coordinate system generated by the third color conversion unit for estimating a currently encoded block.

6. The apparatus of claim 5, wherein the encoding unit is an intra mode encoding unit.

7. The apparatus of claim 5, wherein the encoding unit is an inter mode encoding unit.

8. An apparatus for encoding color images, comprising:
a single image sensor that is inclined at an angle of 45° in a vertical direction and is arranged to have a diamond shape by treating four pixels as a unit,
wherein two of the four pixels arranged within the single image sensor are green, one thereof is red, and the remaining one is blue.

9. An apparatus for encoding moving pictures, comprising:
a quantization determination unit that determines a quantization step;
an LPF applying unit that designs a low pass filter (LPF) according to the determined quantization step and applies the designed LPF to input images; and
an encoding unit that encodes images outputted from the LPF applying unit to generate compressed images.

10. An apparatus for encoding moving pictures, comprising:
a first quantization unit that quantizes transform coefficients using a first quantization step;
an energy calculation unit that calculates an energy value in a specific frequency band of the quantized transform coefficients; and
a second quantization unit that determines a second quantization step when the calculated energy value is equal to or larger than a preset threshold and quantizes the transform coefficient using the determined second quantization step.

11. An apparatus for decoding compressed signals obtained by encoding sampled color signals using a CFA without interpolation, comprising:
a decoding unit that decodes the received compressed signals to generate decoded color signals of a second color coordinate system;
a first color conversion unit that inversely converts the decoded color signals of the second color coordinate system to generate decoded sampled color signals of a first color coordinate system;
a full color interpolation unit that interpolates the decoded sampled color signals of the first color coordinate system to generate decoded full resolution color signals of the first color coordinate system; and
a second color conversion unit that converts the decoded full resolution color signals of the first color coordinate system to generate decoded full resolution color signals of the second color coordinate system,
wherein the decoding unit uses the decoded full resolution color signals of the second color coordinate system generated by the second conversion unit as a reference image of a currently decoded block.

12. An apparatus for decoding color images, comprising:
a quantization coefficient calculation unit that decodes the received compressed signals to calculate quantized transform coefficients;
an energy calculation unit that calculates an energy value in a specific frequency band of the calculated quantized transform coefficients; and
a dequantization unit that compares the calculated energy value with a preset threshold and dequantizes the quantized transform coefficients using different quantization steps according to the comparison results.

13. A method for encoding color images, comprising:
acquiring color images of a first color coordinate system;
converting the acquired sampled color images of the first color coordinate system into color images of a second color coordinate system without interpolation by treating a preset number of pixels as a unit; and
performing encoding to generate a compressed image by estimation, calculating residual errors and applying transform by considering the fact that some pixels on an identical horizontal axis in the second color coordinate system are originally located on different horizontal axes in the first color coordinate system.

14. The method of claim 13, wherein the first color coordinate system is an RGB color coordinate system.

15. The method of claim 13, wherein the second color coordinate system is a YUV color coordinate system.

16. A method for encoding sampled color signals using a single image sensor having a CFA without interpolation, comprising:
converting color signals of a first color coordinate system sampled using the CFA into a second color coordinate system without interpolation;
encoding color signals of the second color coordinate system;
decoding the encoded color signals of the second color coordinate system to generate the decoded color signals of the second color coordinate system;
inversely converting the decoded color signals of the second color coordinate system to generate the decoded sampled color signals of the first color coordinate system;
interpolating the decoded sampled color signals of the first color coordinate system to generate decoded full resolution color signals of the first color coordinate system; and
converting the generated decoded full resolution color signals of the first color coordinate system to generate decoded full resolution color signals of the second color coordinate system,
wherein in the encoding, the generated decoded full resolution color signals of the second color coordinate system are used for estimating a currently encoded block.

17. A method for encoding moving pictures, comprising:
determining a quantization step;
designing a low pass filter (LPF) according to the determined quantization step and applying the designed LPF to an input image; and
encoding images outputted from the LPF applying unit to generate compressed images.

18. A method for encoding moving pictures, comprising:
quantizing transform coefficients using a first quantization step;
calculating an energy value in a specific frequency band of the quantized transform coefficients; and
determining a second quantization step when the calculated energy value is equal to or larger than a preset threshold and quantizing the transform coefficients using the determined second quantization step.

19. A method for decoding compressed signals obtained by encoding sampled color signals using a CFA without interpolation, comprising:
decoding the received compressed signal to generate decoded color signals of a second color coordinate system;
inversely converting the decoded color signals of the second color coordinate system to generate the decoded sampled color signals of the first color coordinate system;
interpolating the decoded sampled color signals of the first color coordinate system to generate decoded full resolution color signals of the first color coordinate system; and
converting the decoded full resolution color signals of the first color coordinate system to generate decoded full resolution color signals of the second color coordinate system,
wherein in the decoding, the decoded full resolution color signals of the second color coordinate system are used as a reference image of a currently decoded block.

20. A method for decoding color images, comprising:
decoding the received compressed signals to calculate quantized transform coefficients;
calculating an energy value in a specific frequency band of the calculated quantized transform coefficients; and
comparing the calculated energy value with a preset threshold and dequantizing the quantized transform coefficients using different quantization steps according to the comparison results.
